(19) United States
(12) Patent Application Publication
(10) Pub. No.: US 2016/0150311 A1
(43) Pub. Date: May 26, 2016

(54) METHODS AND SYSTEMS FOR PROCESSING SOUND WAVES

(71) Applicant: Peak Audio LLC, McPherson, KS (US)

(72) Inventor: Matt Bremyer, Laramie, WY (US)

(21) Appl. No.: 14/550,792

(22) Filed: Nov. 21, 2014

(51) Int. Cl. H04R 1/10

(52) U.S. Cl. CPC H04R 1/1091

(57) ABSTRACT

One or more specific embodiments disclosed herein includes a headphone device comprising a first ear cup, a speaker transducer capable of producing sound waves, and a first disc comprising a non-woven felt. The first disc comprises a surface. The first disc is positioned adjacent to the speaker transducer such that the surface of the first disc is substantially perpendicular to the direction of travel of the sound waves.

### BACKGROUND

1. Field of Inventions

The field of this application and any resulting patent is sound wave processing.

2. Description of Related Art

Various methods and devices have been proposed and utilized to process distance, including the methods and devices disclosed in the references appearing on the face of this patent. However, these methods and devices lack all the steps or features of the methods and devices covered by the patent claims below. As will be apparent to a person of ordinary skill in the art, the methods and systems covered by the claims of this issued patent solve many of the problems that prior art methods and systems fail to solve. Also, it will be apparent that the methods and systems covered by the claims of this patent have unpredictable and/or surprising benefits and overcome many of the shortcomings inherent in prior art methods and systems.

### SUMMARY

One or more specific embodiments disclosed herein includes a headphone device comprising a first ear cup, a speaker transducer capable of producing sound waves, and a first disc comprising a non-woven felt, wherein the first disc comprises a surface, and the first disc is positioned adjacent to the speaker transducer such that the surface of the first disc is substantially perpendicular to the direction of travel of the sound waves.

One or more specific embodiments disclosed herein includes a headphone device comprising a first ear cup and a second ear cup connected to a frame, wherein the first ear cup and the second ear cup each comprises an opening, and the opening of the first ear cup and the opening of the second ear cup are positioned to substantially face one another, wherein the first ear cup and the second ear cup each encloses at least partially one or more discs, at least one of which comprises polyethylene terephthalate, and a speaker transducer capable of converting a signal to audible sound, wherein the speaker transducer comprises a magnet, a voice coil, and a diaphragm that is coupled to the voice coil.

One or more specific embodiments disclosed herein includes a headphone device comprising a flexible frame, a first ear cup coupled to the flexible frame, and a second ear cup coupled to the flexible frame, wherein the first ear cup and the second ear cup each includes an opening shaped to accommodate a human ear, the first ear cup and the second ear cup each at least partially enclosing one or more discs, at least one of which comprises polyethylene terephthalate, and a speaker transducer capable of converting an audio signal to audible sound, the speaker transducer comprising a magnet, a voice coil, and a diaphragm that is coupled to the voice coil.

### BRIEF DESCRIPTION OF THE DRAWINGS

FIG. 1 is an exterior side view of a headphone device.

FIG. 2 is an exterior top view of a headphone device.

FIG. 3 is an exterior front view of a headphone device.

FIG. 4 is an exterior perspective view of a headphone device.

FIG. 5 is an exploded view of interior components of an earpiece of a headphone device.

FIG. 6 is an interior view of an earpiece of a headphone device.

FIG. 7 is an exploded view of a simplified depiction of the movement of sound waves within a headphone device.

FIG. 8 is a graph of data for responses of an ear cup of a prototype headphone device.

FIG. 9 is a graph of data for responses of an ear cup of a prototype headphone device.

FIG. 10 is a graph of data for responses of an ear cup of a control headphone device.

FIG. 11 is a graph of data for responses of an ear cup of a control headphone device.

FIG. 12 is a graph of data for total harmonic distortion of an ear cup of a prototype headphone device.

FIG. 13 is a graph of data for total harmonic distortion of an ear cup of a prototype headphone device.

FIG. 14 is a graph of data for total harmonic distortion of an ear cup of a control headphone device.

FIG. 15 is a graph of data for total harmonic distortion of an ear cup of a control headphone device.

### DETAILED DESCRIPTION

### 1. Introduction

A detailed description will now be provided. The purpose of this detailed description, which includes the drawings, is to satisfy the statutory requirements of 35 U.S.C. §112. For example, the detailed description includes a description of the inventions and sufficient information that would enable a person having ordinary skill in the art to make and use the inventions referenced in the claims. In the Figures, like elements are generally indicated by like reference numerals regardless of the view or Figure in which the elements appear. The Figures are intended to assist the description and to provide a visual representation of certain aspects of the subject matter described herein. The Figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in printed publications, dictionaries, and issued patents.

### 2. Selected Definitions

Certain claims include one or more of the following terms which, as used herein, are expressly defined below.

The term “ear cup” as used in the claims is broadly defined herein as any cup-shaped structure, preferably one shaped to cover an adult human ear. An ear cup may comprise a material that may be not capable of elastic deformation above a force of 50 psi. An ear cup may be capable of at least partially encasing a speaker transducer, a disc, or both the speaker transducer and the disc. An ear cup may comprise carbon fiber, one or more polymers, metal (e.g. titanium), any other substance well known to persons having skill in the art, or any combination of these materials.

The term “signal” as used in the claims is broadly defined herein as an electrical impulse or radio wave. A signal may be capable of transmitting audio data from a source to a destination. A signal may comprise an alternating current. A signal may comprise radio waves or electrical impulses corresponding to audio data that may be transmitted from an audio source to a headphone device. A signal may be transmitted directly or indirectly from an audio source to a headphone device. A signal may be transmitted directly or indirectly from a microphone to a processor or from a processor to a speaker transducer. A signal may comprise radio waves capable of wireless transmission from a source to a receiver. A signal may comprise radio waves ranging in frequency from 2.4 GHz to 2.485 GHz.

The term “disc” as used in the claims is broadly defined herein as any compressible structure or combination of structures. A disc may be cylindrical in shape in its uncompressed state. A disc may be cylindrical in shape when compressed into a cylindrical opening. A disc may have curved surfaces. A disc may have flat, rounded surfaces. A disc may be capable of causing changes to sound waves. A disc may be capable of influencing sound waves at least partially due to the structure of the disc (e.g., open-celled foam, closed-cell foam, non-woven felt). A disc may be capable of influencing sound waves at least partially due to the substance or substances that make up the disc (e.g., polymer-based closed-cell foam with carbon dioxide-filled cells). The disc may have a density of 0.5 cm³/g, 0.75 cm³/g, 1.0 cm³/g, 1.10 cm³/g, 1.25 cm³/g, or 1.5 cm³/g to 1.0 cm³/g, 1.25 cm³/g, 1.5 cm³/g, 1.75 cm³/g, 2.0 cm³/g, 2.5 cm³/g, 3.0 cm³/g, 3.5 cm³/g, or 4.0 cm³/g. A disc may have a thickness ranging from 0.1 cm, 0.25 cm, 0.5 cm, 1.0 cm, 1.5 cm, 2.0 cm, or 2.5 cm to 0.25 cm, 0.5 cm, 0.75, 1.0 cm, 2.0 cm, 2.5, cm, 3.0 cm, 3.5 cm, 4.0 cm, 5.0 cm, 6.0 cm, or 7.0 cm. A disc may comprise a matted, non-woven felt material formed from polymer fibers (e.g., polyethylene terephthalate fibers). A disc may comprise more than one material (e.g., fibers from two or more different types of polymers matted into a single felt sheet). A disc may comprise a supportive structure (e.g., a scrim). A disc may comprise a supportive structure positioned adjacent to and/or coupled to one or more surfaces of the disc. A disc may comprise a supportive structure comprising a scrim positioned within the body of the disc. A disc may be shaped to approximately fit the container in which it is placed. A disc may comprise two or more separate sections of material that may be joined together. A disc may comprise two or more separate sections of material that are separated by a structure such that the sections do not make direct contact with one another. Alternatively, the disc may comprise a single section of material. A disc may be capable of being compressed without permanent damage to the disc. After a compression force is removed, a disc may be capable of expanding to a size larger than the size of a compressed disc. When a disc and a speaker transducer are in an enclosure and the enclosure is substantially filled with the disc, the disc may be capable of dampening sound and/or removing distortion produced from the speaker transducer for some, most, or substantially all audible frequency ranges. When a disc and a speaker transducer are in an enclosure and the enclosure is substantially filled with the disc, the disc may be capable of dampening sound and/or removing distortion of one or more frequency ranges produced from the speaker transducer and permitting other frequency ranges to pass through unimpeded. A disc may be any of the products distributed by Western Upholstery Supply (www.westernupholsterysupply.com) (e.g., ¼″ or ½″ scrim foam and 30″ wide or 60″ wide split-able Dacron®). A disc may be any of the products manufactured by Future Foam Inc. (www.futurefoam.com) (e.g., ¼″ scrim foam) or by Products Unlimited Inc. (located at 4450 Commercial Ave., Omaha, Nebr. 68110) (e.g., 30″ wide split-able Dacron®).

The term “audio” as used in the claims is broadly defined herein as pertaining to sound, particularly that within the hearing range of humans (i.e., 20 Hz to 20 kHz). Audio signals may be digital signals or analog signals capable of being converted to produce audible sound.

The term “frame” as used in the claims is broadly defined herein as an elongated structure shaped to form an arc comprising a material having at least some rigidity. A frame may comprise a material that may not capable of elastic deformation above a force of 50 psi. A frame may be shaped to accommodate a human head. A frame may range in width from 0.5 in., 0.75 in., or 1.0 in. to 0.75 in., 1.0 in., 1.25 in., 1.5 in., 1.75 in., 2.0 in., 2.5 in., or 3.0 in. A frame may be capable of being altered in its overall length in order to accommodate differently-sized human heads. A frame may comprise more than one section, and these sections may be capable of sliding relative to one another in order to alter the overall length of the frame. A frame may comprise titanium, carbon fiber, polymer, or a combination of two or more of these materials. A frame may comprise additional materials that are well known to a person having ordinary skill in the art for use in constructing frames.

The term “opening” as used in the claims is broadly defined herein as a portion of a surface of an object that is inset or removed from the remaining portion of the surface of the object. An opening may exist if a line formed from connecting two points forming the border of the opening on a surface of an object does not pass through the object. An opening may be a concave inset. For example, an ear cup may comprise an opening on one or more sections of a surface of the ear cup. An opening on an ear cup may be capable of accommodating a human ear.

The term “magnet” as used in the claims is broadly defined herein as an object that is capable of producing a measurable magnetic field. A magnet may be an object that permanently produces a measurable magnetic field. Alternatively, a magnet may be an object that is capable of being induced to produce a measurable magnetic field. A magnet may be substantially stationary relative to an ear cup. Alternatively, a magnet may be capable of being changed in position relative to an ear cup.

The term “diaphragm” as used in the claims is broadly defined herein as a thin membrane. A diaphragm may comprise a semi-rigid material. A diaphragm may comprise a cellulose-based material, a polymer, or any other material well known to a person having ordinary skill in the art of producing or repairing speaker transducers. A diaphragm may be coupled to a voice coil near the center of the diaphragm. A diaphragm may be coupled to an object that remains stationary relative to a moving voice coil.

The term “voice coil” as used in the claims is broadly defined herein as a length of wire formed into a circular shape. A voice coil may be a wire that has been wound in circular, overlapping layers to form a spring-like structure. A voice coil may comprise a magnetic substance. A voice coil may be capable of having one end of the wire coupled to a diaphragm such that movement of the voice coil causes corresponding movement of the diaphragm. A voice coil may comprise a conductive material (e.g., copper). Wire used to form a voice coil may comprise flat wire, round wire, or other kinds of wire well known in the art. A voice coil may be capable of receiving an audio signal.

The term “coupled to” as used in the claims is broadly defined herein as being integral with (part of) or being directly or indirectly attached to. For example, a diaphragm may be coupled to a voice coil such that movement of the voice coil causes movement of at least some portion of the diaphragm. A voice coil may be coupled to a portion of a diaphragm, e.g., at or near the outer circumference of the diaphragm or the circumference of a smaller section forming a concentric circle section with the outer circumference of the diaphragm. A first object that is coupled to a second object may be removable without damage to either object. A first object may be substantially permanently coupled to a second object.

The term “flexible” as used in the claims is broadly defined herein as capable of bending at an angle of 3 degrees or greater without permanently deforming. A flexible frame may be capable of bending to permit a first ear cup and a second ear cup positioned on either end of the flexible frame to be pulled apart to increase the distance between the first ear cup and the second ear cup. A flexible frame may be capable of returning to substantially the same shape when a force causing the frame to bend is removed.

The term “face” or “faces” as used in the claims is broadly defined herein as point(s) in a particular direction. For example, a planar surface may face an object when a second plane perpendicular to the planar surface is directed to pass through the object. For example, an opening on a surface of an ear cup may face a direction that is substantially perpendicular from a plane formed from 3 points bordering the opening on the surface of the ear cup. For example, two openings on two surfaces of two ear cups may face in substantially the same direction or substantially face one another when two planes formed from 3 points on the border of each of the two openings on the two surfaces are approximately parallel with one another. For example, two openings on two surfaces of two ear cups may face in substantially the same direction or substantially face one another when two planes formed from 3 points on the border of each of the two openings on the two surfaces are skewed from parallel by 5, 10, 15, or 20 degrees or less.

The term “cushion” as used in the claims is broadly defined herein as a material or object that is capable of reversibly compressing when force is applied to it. A cushion may comprise an outer material and an inner material. The outer material may comprise a fabric. The inner material may comprise foam, felt, or other reversibly compressible material. The outer material may comprise a natural fabric such as cotton or a synthetic fabric such as polyurethane.

The term “fill” as used in the claims is broadly defined herein as fully or partially occupy empty space. For example, a disc may be compressible such that when the compressed disc is placed in an ear cup, it may be capable of expanding to substantially the same volume as the unoccupied portions of the ear cup to substantially fill the ear cup. For example, an ear cup may be substantially filled with a disc even though the disc itself includes portions of empty space (e.g., the open cells of foam or the air within a felt material). For example, a disc may be sized to at least partially fill an ear cup if the disc is capable of contacting opposite sides of the ear cup directly or indirectly or the disc is capable of expanding to contact opposite sides of the ear cup directly or indirectly.

The term “translucent” as used in the claims is broadly defined herein as capable of permitting at least some light to pass through, but not transparent. A translucent material may be capable of scattering light as it passes through the translucent material.

The term “capacitive sensing” as used in the claims is broadly defined herein as capable of recognizing conductive material. A capacitive sensing surface may be capable of recognizing a touch from human skin. A capacitive sensing surface may be capable of forming a capacitor upon contact with a conductive object.

### 3. Certain Specific Embodiments

Now, certain specific embodiments are described, which are by no means an exclusive description of the inventions. Other specific embodiments, including those referenced in the drawings, are encompassed by this application, and any patent that issues therefrom.

One or more specific embodiments disclosed herein includes a headphone device which may comprise a first ear cup, a speaker transducer capable of producing sound waves, and a first disc which may comprise a non-woven felt, wherein the first disc may comprise a surface, and the first disc may be positioned adjacent to the speaker transducer such that the surface of the first disc may be substantially perpendicular to the direction of travel of the sound waves.

One or more specific embodiments disclosed herein includes a headphone device which may comprise a first ear cup and a second ear cup connected to a frame, wherein the first ear cup and the second ear cup may each comprise an opening, and the opening of the first ear cup and the opening of the second ear cup may be positioned to substantially face one another, wherein the first ear cup and the second ear cup may each enclose at least partially one or more discs, at least one of which may comprise polyethylene terephthalate, and a speaker transducer which may be capable of converting a signal to audible sound, wherein the speaker transducer may comprise a magnet, a voice coil, and a diaphragm that may be coupled to the voice coil.

One or more specific embodiments disclosed herein includes a headphone device which may comprise a flexible frame, a first ear cup which may be coupled to the flexible frame, and a second ear cup which may be coupled to the flexible frame, wherein the first ear cup and the second ear cup may each include an opening shaped to accommodate a human ear, the first ear cup and the second ear cup may each at least partially enclose one or more discs, at least one of which may comprise polyethylene terephthalate, and a speaker transducer which may be capable of converting an audio signal to audible sound, the speaker transducer may comprise a magnet, a voice coil, and a diaphragm that may be coupled to the voice coil.

One or more specific embodiments disclosed herein includes a method for processing sound waves comprising providing for a headphone device which may comprise a first ear cup, a speaker transducer which may be capable of producing sound waves, and a first disc which may comprise a non-woven felt, wherein the first disc may comprise a surface, and the first disc may be positioned adjacent to the speaker transducer such that the surface of the first disc may be substantially perpendicular to the direction of travel of the sound waves.

One or more specific embodiments disclosed herein includes a method for processing sound waves comprising providing for a headphone device which may comprise a first ear cup and a second ear cup connected to a frame, wherein the first ear cup and the second ear cup may each comprise an opening, and the opening of the first ear cup and the opening of the second ear cup may be positioned to substantially face one another, wherein the first ear cup and the second ear cup may each enclose at least partially one or more discs, at least one of which may comprise polyethylene terephthalate, and a speaker transducer which may be capable of converting a signal to audible sound, wherein the speaker transducer may comprise a magnet, a voice coil, and a diaphragm that may be coupled to the voice coil.

One or more specific embodiments disclosed herein includes a method for processing sound waves comprising providing for a headphone device which may comprise a flexible frame, a first ear cup which may be coupled to the flexible frame, and a second ear cup which may be coupled to the flexible frame, wherein the first ear cup and the second ear cup may each include an opening shaped to accommodate a human ear, the first ear cup and the second ear cup may each at least partially enclose one or more discs, at least one of which may comprise polyethylene terephthalate, and a speaker transducer which may be capable of converting an audio signal to audible sound, the speaker transducer may comprise a magnet, a voice coil, and a diaphragm that may be coupled to the voice coil.

In any of the methods or structures disclosed herein, the first ear cup may further comprise a closed, outer-facing portion and the speaker transducer may be positioned adjacent to the first disc such that the first disc may be closer to the closed, outer-facing portion of the first ear cup than to the speaker transducer.

In any of the methods or structures disclosed herein, the headphone device may further comprise a second disc, wherein the first ear cup may further comprise an open, inner-facing portion, the second disc may be positioned adjacent to the speaker transducer, and the second disc may be closer to the open, inner-facing portion of the first ear cup than the first disc.

In any of the methods or structures disclosed herein, the headphone device may further comprise a second disc, wherein the second disc comprises foam and a scrim.

In any of the methods or structures disclosed herein, the headphone device may further comprise a second disc, wherein the speaker transducer may comprise a magnet, a voice coil, and a diaphragm that may be coupled to the voice coil, and the second disc may be sized to cover at least 75% of a circular face of the diaphragm.

In any of the methods or structures disclosed herein, the speaker transducer may comprise a diaphragm, wherein the diaphragm has a diameter between 20 mm and 70 mm.

In any of the methods or structures disclosed herein, the first ear cup may comprise a cushion and an opening, wherein the cushion may comprise polyurethane and may circumscribe at least a portion of the opening of the first ear cup.

In any of the methods or structures disclosed herein, the first ear cup may further comprise an outer-facing surface, and the outer-facing surface of the first ear cup may include one or more capacitive sensing sections, each of which may be capable of causing one or more commands to be transmitted to a second device.

In any of the methods or structures disclosed herein, the headphone device may further comprise one or more light emitting diodes positioned within the first ear cup, wherein the first ear cup may comprise an outer-facing portion, and the outer-facing portion of the first ear cup may comprise an at least partially translucent material.

In any of the methods or structures disclosed herein, the headphone device may further comprise a power source which may be capable of being at least partially recharged.

In any of the methods or structures disclosed herein, the headphone device may further comprise a receiver which may be capable of wirelessly receiving a signal from a second device.

In any of the methods or structures disclosed herein, the headphone device may further comprise a receiver which may be capable of wirelessly receiving a signal from a second device, wherein the signal received from the second device may be a radio wave ranging in frequency from 2.4 GHz to 2.485 GHz.

In any of the methods or structures disclosed herein, the headphone device may further comprise a flexible frame and one or more light emitting diodes, wherein the flexible frame may at least partially enclose the light emitting diodes, and the flexible frame may comprise an at least partially translucent material.

In any of the methods or structures disclosed herein, the headphone device may further comprise one or more light emitting diodes, each of which may have a red emitter, a blue emitter, and a green emitter, and one or more capacitive sensing sections, wherein the light emitting diodes may be capable of producing an emitted light comprising the combined wavelengths and intensities of the red emitter, the blue emitter, and the green emitter, the emitted light may be capable of being altered by changing the intensities of the red emitter, the blue emitter, the green emitter, or any combination of the three, and the capacitive sensing sections may be capable of sending a signal which may cause the emitted light to be altered.

In any of the methods or structures disclosed herein, the headphone device may further comprise a plug which may be capable of facilitating transmission of a signal directly or indirectly to the speaker transducer.

In any of the methods or structures disclosed herein, the headphone device may further comprise a microphone and a processor, wherein the processor may be capable of receiving a first audio signal from the microphone, and the processor may be capable of generating a second audio signal that may be at least partially based on the first audio signal.

In any of the methods or structures disclosed herein, the first disc may comprise a non-woven felt which may at least partially comprise polyethylene terephthalate fibers.

In any of the methods or structures disclosed herein, the first ear cup may comprise a closed, outer-facing portion, and the first disc may be sized to substantially fill an area between the speaker transducer and the closed, outer-facing portion of the first ear cup.

### 4. Specific Embodiments in the Figures

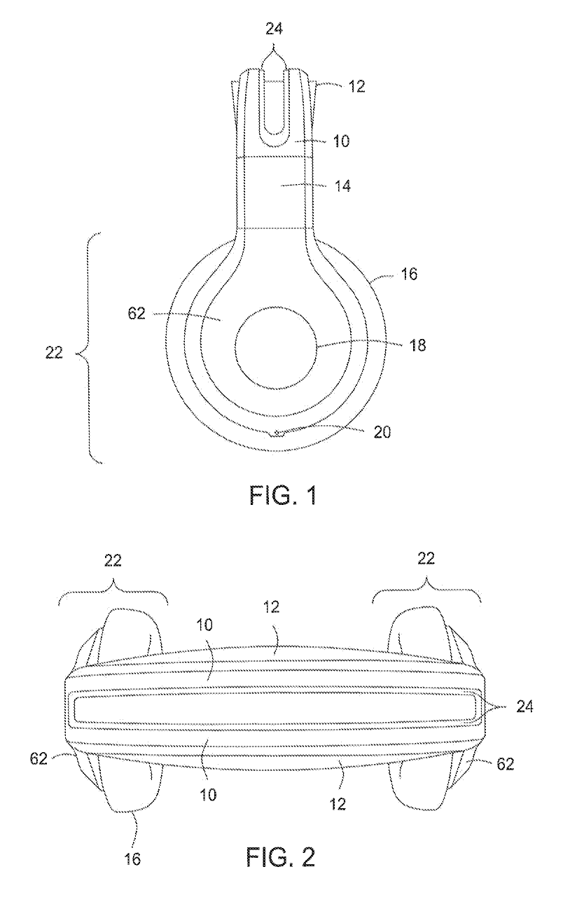

Referring to FIGS. 1, 2, 3, and 4, exterior views of a headphone device are depicted including many features, any one of which may be found in various specific embodiments, including both those that are shown in this specification and those that are not shown.

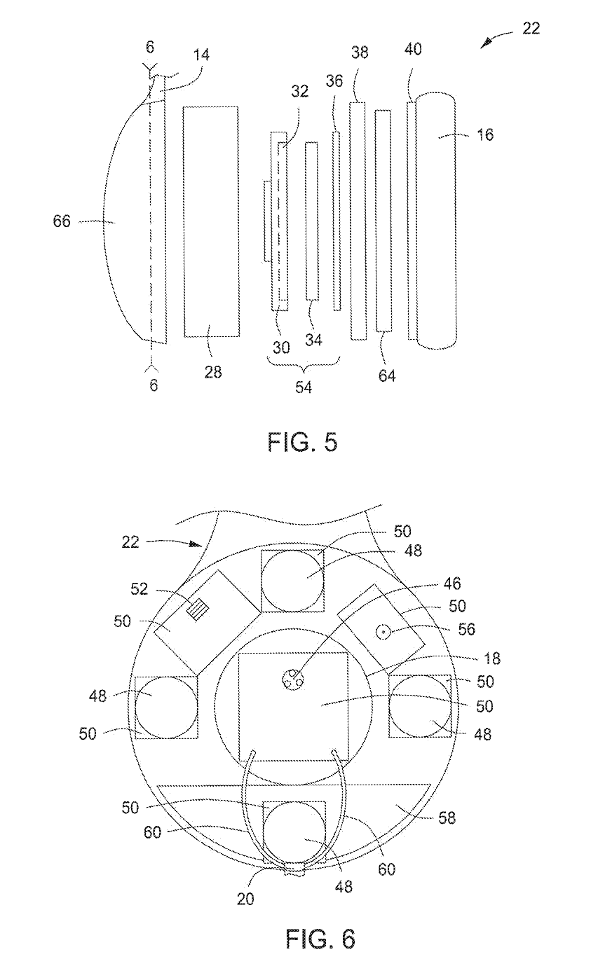

Referring now to FIG. 1, an exterior side view of a headphone device is depicted. A frame 10, which may include titanium and/or carbon fiber or other materials, connects two speaker cups 22. The headphone frame 10 may include one or more expandable sections 14 which may be capable of sliding to extend or shorten the overall length of the headphone frame 10 (distance between cups 22) so as to accommodate a variety of different users. Each speaker cup 22 may include a speaker pad 16 including a compressible material encased (partially or fully) by a sheet which may be a polymer such as polyurethane. The frame 10 may include more than one section which may be connected such that one or more sections may be capable of rotating relative to the rest of the frame 10. The speaker cups 22 may be connected to one such section (e.g. section 14), so that the speaker cups 22 are capable of rotating up to 90, 135, 180, 225, 270, or 360 degrees for storage and other purposes. The speaker cups 22 may include an audio plug 20 on one or both of the speaker cups 22. One audio plug 20 may serve as an audio input plug which may be capable of receiving signals from an external source through a cable or other data link (not shown). Another audio plug 20 may serve as an audio output plug which may duplicate or forward original or altered signals from the original external source to a second audio device, e.g., a second headphone device (not pictured). The audio plugs 20 may utilize a variety of physical audio interface connections capable of transmitting either digital or analog signals, including, but not limited to, a coaxial connection, universal serial bus connection, or TS/TRS/TRRS phone connections in a variety of sizes (e.g., 2.5 mm, 3.5 mm, 4.4 mm, or 6.35 mm). The speaker cups 22 may also include titanium and/or carbon fiber as well as other materials and may be constructed so as to be water resistant. The outermost surface 62 of the speaker cup 22 may include a section 18 that is at least partially translucent such that a light source positioned within the speaker cup 22 may be seen from the exterior of the speaker cup 22 (see, e.g., FIG. 5). The translucent section may be shaped in a variety of ways including, but not limited to, shaped to form a logo or lettering. The topmost section of the frame 10 may include a second section 24 that is at least partially translucent such that a light source positioned beneath second section 24 may be seen from the exterior of the frame 10. The second section 24 may be shaped in a variety of ways including, but not limited to, shaped to form a logo or lettering. The second section 24 may include areas that are touch-sensitive such that one or more controls or features are utilized using the touch-sensitive area. The areas may be capacitive touchscreen panels, resistive touchscreen panels, or a combination of capacitive and resistive touchscreen panels. The touch-sensitive areas of the second section 24 may be capable of causing a RGB light source positioned beneath the second section 24 to change colors. The second section 24 may be inset within the frame 10. The outermost surface 62 of the speaker cups 22 may include areas that are touch-sensitive such that one or more controls or features are utilized using the touch-sensitive area. The areas may be capacitive touchscreen panels, resistive touchscreen panels, or a combination of capacitive and resistive touchscreen panels. The touch sensitive areas of the outermost surface 62 of the speaker cups 22 may be capable of powering the headphones on or off, adjusting the volume level of the headphones, changing an audio source file and/or song, and pausing or playing an audio source file and/or song. A padded headband 12 including a polymer, such as polyurethane may range in width from 1.0 cm, 2.0 cm, 3.0 cm, or 5.0 cm inches to 2.5 cm, 4.0 cm, 6.0 cm, or 8.0 cm and a thickness of 0.5, 1.0, 1.5, or 2.0 mm to 1.0, 1.5, 2.0, 3.0, 5.0, 7.5 or 10.0 mm. The padded headband 12 may further include a compressible material for the comfort of the user.

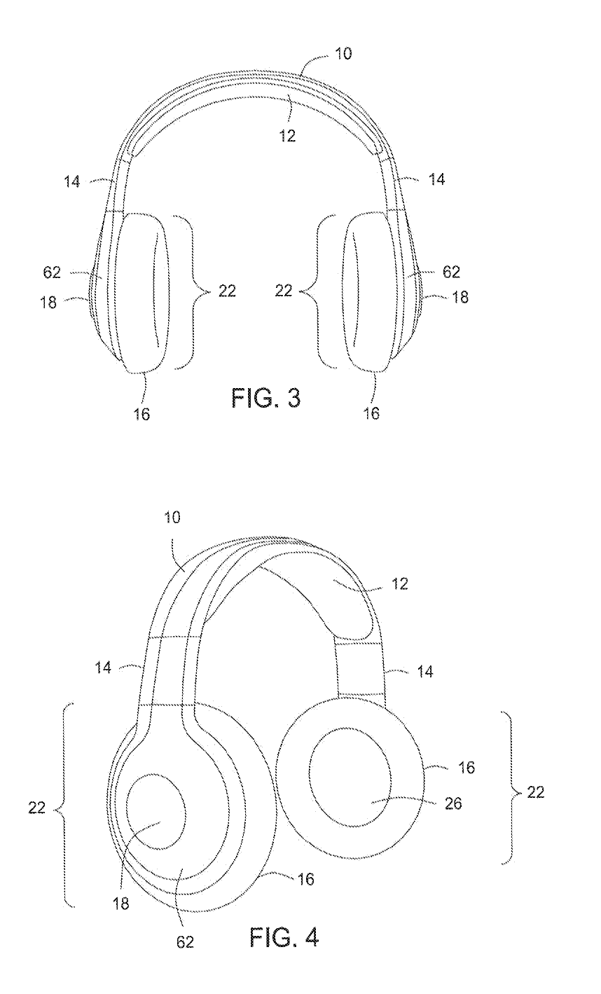

Referring now to FIG. 2, an exterior top view of a headphone device is depicted. The second section 24 may span a length of the frame 10 ranging from 2.5 cm, 5 cm, 7.5 cm, or 10 cm to 5 cm, 10 cm, 15 cm, 20 cm, or 25 cm. Additionally, the padded headband 12 may also span a length of the frame 10 ranging from 5 cm, 7.5 cm, 10 cm, 12.5 cm, 15 cm, 17.5 cm, or 20 cm to 7.5 cm, 10 cm, 15 cm, 20 cm, 25 cm, or 30 cm. Referring now to FIG. 3, an exterior front view of a headphone device is depicted. Referring now to FIG. 4, an exterior perspective view of a headphone device is depicted. The speaker cup 22 may include a speaker screen 26 having a permeable material that permits sound to travel from the headphone speaker to the user's ear while minimizing the effects to the fidelity of the sound.

Referring now to FIG. 5, an exploded view of several interior components of an earpiece of a headphone device is depicted. Several elements of the headphone device responsible for sound production 54 are contained within the speaker cup 22. The speaker cup 22, when assembled, may be substantially, but not completely, air-tight. A disc 28 including polyethylene terephthalate (e.g., Dacron® fiber) may be positioned within the speaker cup 22 such that the disc 28 is closer to the outer section 66 of the speaker cup 22 than to the sound-producing elements 54 of the headphone device. The disc 28 may be positioned adjacent to several other electronic components connected to the inside face of the outer section 66 of the speaker cup 22 (see FIG. 6). The disc 28 may be a non-woven mat or a woven fiber mat. The disc 28 may vary in thickness from 0.5 cm, 1.0 cm, 2.0 cm, 2.5 cm, or 3.0 cm to 2.0 cm, 2.5 cm, 5.0 cm, 6.0 cm, 6.5 cm, or 7.5 cm. The disc 28 may be sized such that the disc 28 directly or indirectly contacts substantially all points around the interior surfaces of the speaker cup 22. The disc 28 may alternatively be sized such that the circumference of the disc 28 is smaller than the inner circumference of the speaker cup 22. The disc 28 may alternatively be sized and shaped such that one or more portions of the circumference of the disc 28 contacts the interior circumference of the speaker cup 22, but not the entire circumference of the disc 28. The sound-producing elements 54 of the headphone device include a magnet 30, a voice coil 34, and a diaphragm 36. The magnet 30 may include a material capable of being magnetized. The material comprising the magnet 30 may be chosen so as to reduce the overall weight of the headphone device. The magnet 30 may be sized as to be from 20, 25, 30, 35, or 40 mm in diameter to 30, 35, 40, 45, 50, 55, 60, or 65 mm in diameter. The magnet 30 may have a rounded inset 32 in which the voice coil 34 may be positioned. The voice coil 34 may include a conductive material including, but not limited to, copper, aluminum, or a combination of the two. The voice coil 34 may be wired to receive inputs directly from the audio input plug. Alternatively, the voice coil 34 may be wired to receive inputs indirectly from the audio input plug, e.g., from a controller chip that is wired to the audio input plug (see, e.g., FIG. 6). The inputs received from the audio input plug may be analog input signals. The electronic signals received by the voice coil 34 may cause the voice coil 34 to move with respect to the magnet 30 by compressing or expanding the voice coil 34. The diaphragm 36 may be connected to the voice coil 34 such that movement of the voice coil 34 causes corresponding movement of the diaphragm 36. The diaphragm 36 may also be connected to the magnet 30. The diaphragm 36 may include cellulose, one or more polymers, or other materials known in the art. A driver face plate 38 may connect to the outer section 66 of the speaker cup 22 to substantially enclose the sound-producing elements 54. A speaker pad 16 may be connected to the outer section 66 of the speaker cup 22 by a speaker pad base 40. Scrim foam 64 may be positioned between the speaker pad 16 and the diaphragm 36. The scrim foam 64 may range in thickness from 3.0 mm, 4.5 mm, 5.0 mm, or 6.5 mm to 5.0 mm, 6.5 mm, 7.5 mm, 9.0 mm, 10 mm, or 12 mm. The scrim foam 64 may be adjacent to the speaker screen (26, see FIG. 4) such that the scrim foam 64 is closer to the outer section 66 of the speaker cup 22 than the speaker screen.

Referring now to FIG. 6, an interior view of an earpiece of a headphone device is depicted. FIG. 6 depicts the inside of the outer section 66 of the speaker cup 22 as indicated on FIG. 5 by the dashed line. Components shown in FIG. 6 may be positioned such that the components are closer to the outer section of the speaker cup 22 than the disc (28, FIG. 5). The disc may be pressed against the various components shown in FIG. 6. The speaker cup 22 may have one or more touch-sensitive areas on the outer face of the speaker cup 22 that correspond to capacitive touch sensors 48. Each capacitive touch sensor 48 may perform a function when a particular motion is made on the surface of the touch-sensitive area (e.g., a left to right swipe may perform a different function from a tap or a top to bottom swipe). Different capacitive touch sensors 48 may have different control functions. Capacitive touch sensors 48 may be used to power the headphones on or off, adjust the volume level of the headphones, change the audio source file and/or song, pause or play the audio source file and/or song, and change the light output of one or more RGB light-emitting diodes (LEDs) 46. Each capacitive touch sensor 48 may be connected to one or more controller chip 50. The inputs to the capacitive touch sensors 48 may be received by the controller chip 50. The LED 46 may be positioned inside the speaker cup 22 such that the output of the LED 46 may be seen through the translucent section 18. The LED 46 may be capable of producing light output in a wide spectrum of colors by manipulating the intensity of each of the red, green, and blue portions of the LED 46. The output color of the LED 46 may be controlled by controller chip 50 which may also be used to accept and interpret signals from one or more of the capacitive touch sensors 48. The LED 46 may be partially or fully embedded in the translucent section 18 so as to diffuse the light output over a greater area. Controller chip 50 may be used to control the color and intensity of the LED 46 using the input from one or more of the capacitive touch sensors 48.

Audio signals received by the headphones may be received through the audio plug 20 which may be connected to send the signals through connections 60 to controller chip 50. The audio plug 20 may send signals directly to the sound-producing elements of the speaker (e.g., the voice coil 34, FIG. 5). Alternatively, audio signals may be received by the headphones through a wireless receiver 56. The wireless receiver 56 may utilize a separate controller chip 50 which may be capable of receiving wireless signals and translating them to sound. The wireless receiver 56 may operate on Bluetooth® wireless technology standard [IEEE Standard 802.15.1]. The headphones may also include a speaker 52 for receiving noise from the surrounding environment to be used for noise cancelling purposes. This speaker 52 may be used to receive sound waves from the surrounding environment and send corresponding signals to controller chip 50. Controller chip 50 may then create an inverted signal which is 180 degrees out of phase with the audio signal from the surrounding environment. The combination of the two signals may operate to cancel one another out, resulting in a final audio product for the user that may reduce the volume of sound from the surrounding environment to a level undetectable by human ears. The headphone device may include a power source 58 which powers various components, such as the noise-cancelling speaker 52. The power source 58 may be a rechargeable lithium-ion battery, a rechargeable nickel cadmium battery, or any other rechargeable battery type known in the art. The power source 58 may include a direct or indirect connection to an AC or DC power outlet. When a rechargeable battery power source 58 is plugged into an outlet, the headphone device may use the power from the outlet directly rather than use power stored in the rechargeable battery.

Each of the electrical components described in FIG. 6 may be controlled by a single main controller chip 50 or multiple controller chips 50 within the speaker cup 22 that may capable of sending and receiving signals between one another. The power source 58 may be directly or indirectly connected to one or more of the controller chips 50. The components shown in FIG. 6 may be at least partially coated in a hydrophobic material such that the electrical components are not capable of being damaged when exposed to water.

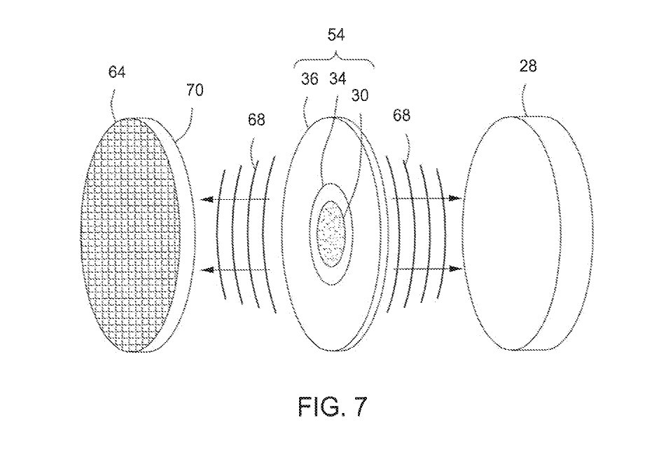

Referring now to FIG. 7, an exploded view of a simplified illustration demonstrating the movement of sound waves within a headphone device is depicted. Sound-producing elements 54 of the headphone device, including a magnet 30, a voice coil 34, and a diaphragm 36, are depicted as positioned between two structures: a scrim foam disc 64 and a disc 28 comprising polyethylene terephthalate (e.g., Dacron® fiber). The scrim foam disc 64 may include an open-cell or closed cell foam. The scrim foam disc 64 may comprise a backing 70 including a scrim support structure. The scrim foam disc 64 may be positioned adjacent to the sound-producing elements 54 such that the scrim foam disc 64 is closer to an ear of a user than the sound-producing elements 54. The disc 28 comprising polyethylene terephthalate may be positioned adjacent to the sound-producing elements 54 such that the disc 28 is further from the ear of the user than the sound-producing elements 54. The magnet 30 may be fixed within the headphone device. The outer circumference of the diaphragm 36 may be fixed with respect to an ear cup of the headphone device in which the diaphragm 36 is housed. The voice coil 34 may be coupled to a portion of the diaphragm 36 at a position radially inward from the outer circumference of the diaphragm 36. The sound-producing elements 54 may produce sound waves 68 when the voice coil 34, coupled to the diaphragm 36, moves with respect to the fixed magnet 30 due to the changes in the input signal to the voice coil 34. The voice coil 34 may cause the portion of the diaphragm 36 positioned radially inward from the outer circumference of the diaphragm 36 to move with respect to the fixed, outer circumference of the diaphragm 36. This movement may cause the inner portion of the diaphragm 36 to alternate from moving toward the disc 28 to away from the disc 28. The movement of the diaphragm 36 may cause compression of the air within the ear cup, forming sound waves 68 whose frequency depends on the speed of the movement of the diaphragm 36.

### 5. Figures Regarding Superior Performance

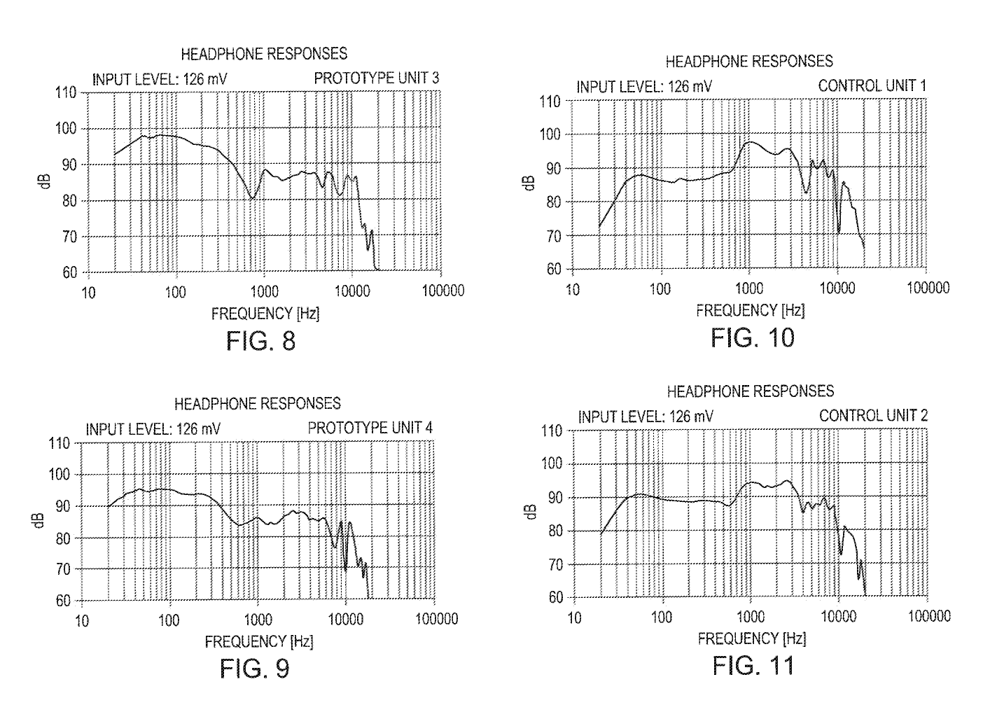

Referring now to FIGS. 8-15, graphs are depicted showing substantive differences between four different headphone units. The first two headphone units each includes a speaker transducer capable of receiving an audio signal, a first disc comprising polyethylene terephthalate, and a second disc, wherein the first disc is sized to at least partially fill a first ear cup. The second disc is positioned adjacent to the speaker transducer such that the second disc is closer to an open, inner-facing portion of the first ear cup than to the speaker transducer. The first disc is positioned adjacent to the speaker transducer such that the first disc is closer to a closed, outer-facing portion of the first ear cup than to the speaker transducer. The remaining two headphones are control units and include two headphone units without a first disc or a second disc positioned adjacent to the speaker transducer. The data shown depicts the readings from the right ear cup of each of the four units.

FIGS. 8-11 graphically depict the average value of five headphone output responses over a range of frequencies given a set input voltage. FIGS. 8 and 9 show this data for the right ear cup of the two prototype headphone units. FIGS. 10 and 11 show this data for the right ear cup of the two control headphone units.

When comparing FIGS. 8 and 9 to FIGS. 10 and 11, a difference in the output levels of lower frequency sounds is apparent. All four units were tested using the same input level (126 mV). The sound production values of the two control units at 20 Hz, the lowest tested frequency, are 72.41 dB and 78.88 dB. In contrast, the two prototype units have sound production values of 89.84 dB and 92.59 dB. The difference of the averages of these pairs of values is 15.57 dB. The decibel scale is a logarithmic scale, and an increase of 10 dB corresponds to a sound that is twice as loud as the first. This difference persists through much of the lower frequencies. At 30 Hz, the control headphones' sound production is 80.39 dB and 86.10 dB, while the prototype headphones' sound production is 93.16 dB and 95.63 dB. The control headphones' sound production does not have an output comparable to the prototype headphones until about 50 Hz, where the control headphone outputs are 87.40 dB and 90.89 dB and the prototype headphone outputs are 94.96 dB and 97.31 dB. However, even at this level, the outputs for the control headphones in the range of 50 Hz to 200 Hz span from 85.54 dB to 87.94 dB and from 88.56 db to 91.04 dB, several decibels lower than the span of the prototype headphones from 93.74 dB to 95.14 dB and from 94.96 dB to 97.98 dB. Keeping in mind the fact that the decibel scale is a logarithmic scale, even a difference of a few decibels is significant. This difference in values shows that, surprisingly, the prototype headphones provide for sounds of lower frequency to be heard at a higher decibel level than the control headphones given a constant input. The prototype headphones provide for low frequency decibel levels to be closer to the decibel levels of higher frequency sounds, bringing both ends of the frequency spectrum closer to one another in output level than the control headphones.

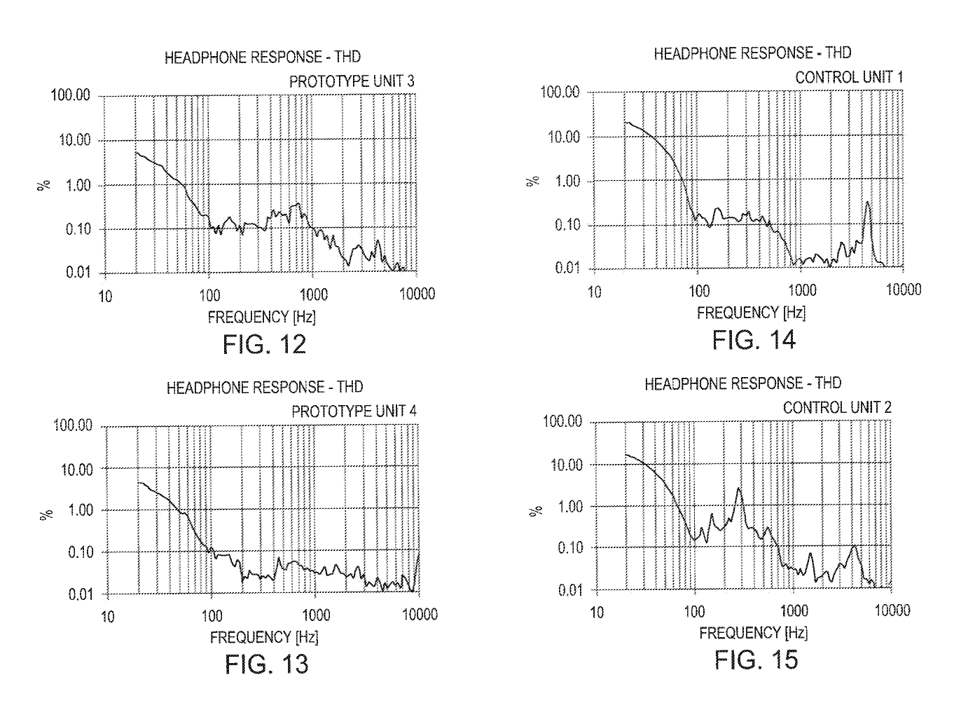

FIGS. 12-15 show graphs depicting the measurement data of the total harmonic distortion (THD) of sound production over a range of frequencies. FIGS. 12 and 13 show this data for the right ear cup of the two prototype headphone units. FIGS. 14 and 15 show this data for the right ear cup of the two control headphone units. Surprisingly, lower THD percentage corresponds to a device that produces a more accurate reproduction of the audio signal by reducing extraneous harmonics.

When comparing FIGS. 12 and 13 to FIGS. 14 and 15, the distortion percentages of the two control units at 20 Hz, the lowest tested frequency, are 20.97% and 16.51%. In contrast, the two prototype units have distortion percentages of 5.29% and 4.54%. The difference of the averages of these pairs of values is 13.825%. At 30 Hz, the control headphones' distortion percentages are 13.54% and 10.61%, while the prototype headphones distortion percentages are 3.22% and 2.65%. The control headphones do not have comparable fidelity to the prototype headphones until about 80-90 Hz, where the control headphone distortion percentages range from 0.20% to 0.50% and 0.19% to 0.40% and the prototype headphone distortion percentages range from 0.19% to 0.25% and 0.13% to 0.17%. The higher fidelity value of the prototype headphones in the lower frequency ranges results in sound that is a more accurate reproduction of the input signal across all audible frequencies instead of just the higher frequencies.

What is claimed as the invention is:

1) A headphone device comprising;
a first ear cup;
a speaker transducer capable of producing sound waves; and
a first disc comprising a non-woven felt, wherein:
the first disc comprises a surface; and
the first disc is positioned adjacent to the speaker transducer such that the surface of the first disc is substantially perpendicular to the direction of travel of the sound waves.

2) A headphone device comprising:
a first ear cup and a second ear cup connected to a frame, wherein:
the first car cup and the second ear cup each comprises an opening; and
the opening of the first ear cup and the opening of the second ear cup are positioned to substantially face one another, wherein the first ear cup and the second ear cup each encloses at least partially:
one or more discs, at least one of which comprises polyethylene terephthalate; and
a speaker transducer capable of converting a signal to audible sound, wherein the speaker transducer comprises:
a magnet;
a voice coil; and
a diaphragm that is coupled to the voice coil.

3) A headphone device comprising:
a flexible frame;
a first ear cup coupled to the flexible frame; and
a second ear cup coupled to the flexible frame, wherein the first ear cup and the second ear cup each includes an opening shaped to accommodate a human ear, the first ear cup and the second ear cup each at least partially enclosing:
one or more discs, at least one of which comprises polyethylene terephthalate; and
a speaker transducer capable of converting an audio signal to audible sound, the speaker transducer comprising:
a magnet;
a voice coil; and
a diaphragm that is coupled to the voice coil.

4) The headphone device of claim 1 wherein:
the first ear cup further comprises a closed, outer-facing portion; and
the speaker transducer is positioned adjacent to the first disc such that the first disc is closer to the closed, outer-facing portion of the first ear cup than to the speaker transducer.

5) The headphone device of claim 1 further comprising a second disc, wherein:
the first ear cup further comprises an open, inner-facing portion;
the second disc is positioned adjacent to the speaker transducer; and
the second disc is closer to the open, inner-facing portion of the first ear cup than the first disc.

6) The headphone device of claim 1 further comprising a second disc, wherein the second disc comprises foam and a scrim.

7) The headphone device of claim 1 further comprising a second disc, wherein:
the speaker transducer comprises a magnet, a voice coil, and a diaphragm that is coupled to the voice coil; and
the second disc is sized to cover at least 75% of a circular face of the diaphragm.

8) The headphone device of claim 1 wherein the speaker transducer comprises a diaphragm, wherein the diaphragm has a diameter between 20 mm and 70 mm.

9) The headphone device of claim 1 wherein the first ear cup comprises a cushion and an opening, wherein the cushion comprises polyurethane and circumscribes at least a portion of the opening of the first ear cup.

10) The headphone device of claim 1 wherein:
the first ear cup comprises an outer-facing surface; and
the outer-facing surface of the first ear cup includes one or more capacitive sensing sections, each of which is capable of causing one or more commands to be transmitted to a second device.

11) The headphone device of claim 1 further comprising one or more light emitting diodes positioned within the first ear cup, wherein:
the first ear cup comprises an outer-facing portion; and
the outer-facing portion of the first ear cup comprises an at least partially translucent material.

12) The headphone device of claim 1 further comprising a power source capable of being at least partially recharged.

13) The headphone device of claim 1 further comprising a receiver capable of wirelessly receiving a signal from a second device.

14) The headphone device of claim 1 further comprising a receiver capable of wirelessly receiving a signal from a second device, wherein the signal received from the second device is a radio wave ranging in frequency from 2.4 GHz to 2.485 GHz.

15) The headphone device of claim 1 further comprising:
a flexible frame; and
one or more light emitting diodes, wherein:
the flexible frame at least partially encloses the light emitting diodes; and
the flexible frame comprises an at least partially translucent material.

16) The headphone device of claim 1 further comprising:
one or more light emitting diodes, each of which has a red emitter, a blue emitter, and a green emitter; and
one or more capacitive sensing sections, wherein:
the light emitting diodes are capable of producing an emitted light comprising the combined wavelengths and intensities of the red emitter, the blue emitter, and the green emitter;
the emitted light is capable of being altered by changing the intensities of the red emitter, the blue emitter, the green emitter, or any combination of the three; and
the capacitive sensing sections are capable of sending a signal which causes the emitted light to be altered.

17) The headphone device of claim 1 further comprising a plug capable of facilitating transmission of a signal directly or indirectly to the speaker transducer.

18) The headphone device of claim 1 further comprising:
a microphone; and
a processor; wherein:
the processor is capable of receiving a first audio signal from the microphone; and
the processor is capable of generating a second audio signal that is at least partially based on the first audio signal.

19) The headphone device of claim 1 wherein the first disc comprises a non-woven felt at least partially comprising polyethylene terephthalate fibers.

20) The headphone device of claim 1 wherein:
the first ear cup comprises a closed, outer-facing portion; and
the first disc is sized to substantially fill an area between the speaker transducer and the closed, outer-facing portion of the first ear cup.
